(19) United States
(12) Patent Application Publication
(10) Pub. No.: US 2019/0293861 A1
(43) Pub. Date: Sep. 26, 2019

(54) DISPLAY APPARATUS

(71) Applicant: SAMSUNG DISPLAY CO., LTD., YONGIN-SI (KR)

(72) Inventors: MIN-GWAN HYUN, SUWON-SI (KR); JINSOO SHIN, SUWON-SI (KR); WEE-JOON JEONG, SEONGNAM-SI (KR); KEUNHO LEE, HWASEONG-SI (KR)

(21) Appl. No.: 16/358,098

(22) Filed: Mar. 19, 2019

(30) Foreign Application Priority Data
Mar. 21, 2018 (KR) 10-2018-0032585

(51) Int. Cl. F21V 8/00

(52) U.S. Cl. CPC G02B 6/0088; G02B 6/0068; G02B 6/0065; G02B 6/0055

(57) ABSTRACT

A display apparatus includes a display panel, a light guide plate disposed under the display panel, a light source unit that faces a light incident surface of the light guide plate, a first support member that includes a first panel support portion disposed parallel to the display panel, a first light guide plate support portion disposed parallel to the first panel support portion, and a first side wall that connects the first light guide plate support portion to the first panel support portion and extends perpendicular to the first panel support portion, a first adhesive member disposed between and attached to the first panel support portion and the display panel, and a first light guide plate adhesive member disposed adjacent to the light incident surface of the light guide plate and between and attached to the light guide plate and the display panel.

This application claims priority under 35 U.S.C. § 119 from, and the benefit of, Korean Patent Application No. 10-2018-0032585, filed on Mar. 21, 2018 in the Korean Intellectual Property Office, the contents of which are herein incorporated by reference in their entirety.

### BACKGROUND

### 1. Technical Field

Exemplary embodiments of the inventive concept are directed to a display apparatus.

More particularly, exemplary embodiments of the inventive concept are directed to a display apparatus that includes a light guide plate.

### 2. Discussion of the Related Art

Recently, a display apparatus that is small and light weight has been manufactured. A cathode ray tube (CRT) display apparatus has been used due to performance and competitive price. However a CRT display apparatus lacks portability. Therefore a display apparatus such as a plasma display apparatus, a liquid crystal display apparatus or an organic light emitting display apparatus has been favored due to small size, light weight and low-power-consumption.

A liquid crystal display apparatus applies a voltage to specific molecular arrangement to change the molecular arrangement. A liquid crystal display apparatus displays an image based on changes of optical properties, such as birefringence, rotatory polarization, dichroism, or light scattering, of a liquid crystal cell due to the changes of the molecular arrangement.

A liquid crystal display apparatus includes a display panel and a light source that generates light, and a light guide plate that guides the light to the display panel. However, a liquid crystal display apparatus includes an additional mold frame, bottom and top chassis, etc., to support the above-described structures, and has a complicated structure, a large thickness, and a wide bezel.

### SUMMARY

One or more exemplary embodiments of the inventive concept provides a display apparatus that has a simple structure and a slim bezel.

According to an exemplary embodiment of the inventive concept, a display apparatus includes a display panel, a light guide plate disposed under the display panel that includes a light incident surface and a light exit surface, a light source unit that faces the light incident surface of the light guide plate, a first support member that includes a first panel support portion disposed parallel to the display panel, a first light guide plate support portion disposed parallel to the first panel support portion, and a first side wall that connects the first light guide plate support portion to the first panel support portion and extends in a direction perpendicular to the first panel support portion, a first adhesive member disposed between the first panel support portion and the display panel and that is attached to the first panel support portion and the display panel, and a first light guide plate adhesive member disposed adjacent to the light incident surface of the light guide plate between the light guide plate and the display panel and that is attached to the light guide plate and the display panel.

In an exemplary embodiment, the light source unit is disposed adjacent to a first side of the display panel, and the first support member is disposed adjacent to a second side of the display panel opposite to the first side.

In an exemplary embodiment, the display apparatus further includes second and third light guide plate adhesive members disposed adjacent to third and fourth sides of the display panel, respectively, where the the third and fourth sides are perpendicular to the first and second sides. Each of the second light guide plate adhesive member and the third light guide plate adhesive member is disposed between the light guide plate and the display panel, and is attached to the light guide plate and the display panel.

In an exemplary embodiment, the display apparatus further includes a second support member that includes a second panel support portion disposed parallel to the display panel, a second light guide plate support portion disposed parallel to the second panel support portion, and a second side wall that connects the second light guide plate support portion to the second panel support portion and extends in a direction perpendicular to the second panel support portion, and a third support member that includes a third panel support portion disposed parallel to the display panel, a third light guide plate support portion disposed parallel to the third panel support portion, and a third side wall that connects the third light guide plate support portion to the third panel support portion and extends in a direction perpendicular to the third panel support portion. The second support member and the third support member are disposed adjacent to third and fourth sides of the display panel, where the third and fourth sides connect the first side to the second side.

In an exemplary embodiment, the display apparatus further includes a second adhesive member disposed between the second panel support portion and the display panel and that is attached to the second panel support portion and the display panel, and a third adhesive member disposed between the third panel support portion and the display panel and that is attached to the third panel support portion and the display panel.

In an example embodiment, the first to third support members are integrally formed as one component, and have a C-shape.

In an exemplary embodiment, portions where the first support member and the second support member meet have a stepped shape or a zigzag shape when viewed in a plan view.

In an exemplary embodiment, the display apparatus further includes an optical sheet disposed between the light guide plate and the display panel. A protrusion protrudes from a side of the optical sheet, an opening is formed at the protrusion. A sheet hook is formed on the first support member, and the sheet hook can be inserted into the opening.

In an exemplary embodiment, a sheet hook opening is formed in the first panel support portion of the first support member, the sheet hook protrudes from a portion of the first side wall, and the protrusion of the optical sheet can be received in the sheet hook opening.

In an exemplary embodiment, the first support member may be formed by bending a metal plate.

In an exemplary embodiment, the display apparatus further includes a second support member that includes a second panel support portion disposed parallel to the display panel, a second light guide plate support portion disposed parallel to the second panel support portion, and a second side wall that connects the second light guide plate support portion to the second panel support portion and extends in a direction perpendicular to the second panel support portion, and a second light guide plate adhesive member disposed between the light guide plate and the display panel and that is attached to the light guide plate and the display panel. The light source unit is disposed adjacent to a first side of the display panel, the first and second support member are disposed adjacent to third and fourth side of the display panel respectively, where the third and fourth sides are perpendicular to the first side. The second light guide plate adhesive member is disposed adjacent to a second side of the display panel opposite to the first side.

In an exemplary embodiment, the light source unit emits blue light to the light guide plate.

In an exemplary embodiment, an inner surface of the first support member is yellow.

In an exemplary embodiment, the light exit surface of the light guide plate includes a quantum dot pattern that includes a quantum dot or a quantum layer.

According to an exemplary embodiment of the inventive concept, a display apparatus includes a display panel, a light guide plate disposed under the display panel and that includes a light incident surface and a light exit surface, a first support member that extends in a first direction and that includes a first panel support portion that is parallel to the display panel, a first light guide plate support portion that is parallel to the first panel support portion, and a first side wall that connects the first light guide plate support portion to the first panel support portion and extends in a direction perpendicular to the first panel support portion, a second support member that extends in a second direction perpendicular to the first direction and that includes a second panel support portion that is parallel to the display panel, a second light guide plate support portion that is parallel to the second panel support portion,, and a second side wall that connects the first light guide plate support portion to the first panel support portion and extends in a direction perpendicular to the first panel support portion, a first adhesive member disposed between the first panel support portion and the display panel, and that is attached to the first panel support portion and the display panel, and a second adhesive member disposed between the second panel support portion and the display panel, and that is attached to the second panel support portion and the display panel. The first support member and the second support member contact each other at a corner portion of the display apparatus, and the first support member and the second support member are slightly shifted at the corner portion.

In an exemplary embodiment, the display apparatus further includes a light source unit that faces the light incident surface of the light guide plate, and a first light guide plate adhesive member disposed adjacent to the light incident surface of the light guide plate between the light guide plate and the display panel, and that is attached to the light guide plate and the display panel.

In an exemplary embodiment, portions where the first support member and the second support member meet have a stepped shape or a zigzag shape when viewed in a plan view.

In an exemplary embodiment, a recessed portion is formed at an end of the first panel support portion of the first support member, and a protrusion that protrudes in the first direction is formed at an end of a second panel support portion of the second support member, wherein the protrusion of the second panel support portion is received in the recessed portion of the first panel support portion.

According to an exemplary embodiment of the inventive concept, a display apparatus includes a display panel, a light guide plate disposed under the display panel and that includes a light incident surface and a light exit surface, a light source unit that faces the light incident surface of the light guide plate, a support member that includes a panel support portion, a side wall and a light guide plate support portion, an adhesive member disposed between the panel support portion and the display panel, and a light guide plate adhesive member disposed adjacent to the light incident surface of the light guide plate between the light guide plate and the display panel, and that is attached to the light guide plate and the display panel. The light exit surface of the light guide plate comprises a quantum dot pattern.

In an exemplary embodiment, the display apparatus further includes a frame that receives the support member and the light source unit, a back plate fixed to the frame and that covers a lower surface of the light guide plate, a reflecting plate disposed between the back plate and the light guide plate, and an additional adhesive member disposed between the frame and the light guide plate support portion of the support member.

According to the present embodiment, a display apparatus includes a display panel, a light guide plate and a support member, and the display panel and the light guide plate can be simply supported and fixed by the support member. Thus, the thickness of the display apparatus can be reduced, and the structure can be simplified.

In addition, a display apparatus may use quantum dots, and in this case, the light source unit emits blue light. Here, unwanted light leakage of the blue light can be reduced due to the yellow surface of the support member.

In addition, the support member of a display apparatus may include first and second support members, and portions where the first support member and the second support member meet have a stepped shape or a zigzag shape when viewed in a plan view, to prevent light leakage at the corner portion of the display apparatus.

In addition, a display apparatus may further include an optical sheet that has protrusions formed thereon. Since each protrusion of the optical sheet is fixed by a corresponding sheet hook of the support member, the optical sheet can be correctly positioned without an additional member, so that a manufacturing process of the display apparatus can be simplified, and the efficiency can be improved.

In addition, the support member may be integrally formed, thereby improving the light leakage blocking effect.

In addition, the support member of the display apparatus may be disposed on only one side or on both sides of the display apparatus and may be replaced with a light guide plate adhesive member. Accordingly, the structure of a display apparatus can be further simplified, the manufacturing process can be simplified, and the efficiency can be improved. Further, a bezel width can be further reduced.

### BRIEF DESCRIPTION OF THE DRAWINGS

FIG. 1 is an exploded perspective view of a display apparatus according to an exemplary embodiment of the inventive concept.

FIG. 2A is a cross-sectional view taken along a line I-I′ of FIG. 1.

FIG. 2B is a cross-sectional view taken along a line II-II′ of FIG. 1.

FIG. 3A is an enlarged perspective view of a portion of a support member of a display apparatus of FIG. 1.

FIG. 3B is a plan view of a portion of a support member of FIG. 3A.

FIG. 4 is an exploded perspective view of a display apparatus according to an exemplary embodiment of the inventive concept.

FIG. 5A is a cross-sectional view taken along a line I-I′ of FIG. 4.

FIG. 5B is a cross-sectional view taken along a line II-II′ of FIG. 4.

FIG. 6 is an enlarged exploded perspective view of a combined structure of an optical sheet and a support member of a display apparatus of FIG. 4.

FIG. 7A is an enlarged perspective view of a portion of a support member of a display apparatus according to an exemplary embodiment of the inventive concept.

FIG. 7B is a plan view of a portion of a support member of FIG. 7A.

FIG. 8 is an exploded perspective view of a display apparatus according to an exemplary embodiment of the inventive concept.

FIG. 9A is a cross-sectional view taken along a line I-I′ of FIG. 8.

FIG. 9B is a cross-sectional view taken along a line II-II′ of FIG. 8.

FIG. 10 is an exploded perspective view of a display apparatus according to an exemplary embodiment of the inventive concept.

FIG. 11A is a cross-sectional view taken along a line I-I′ of FIG. 10.

FIG. 11B is a cross-sectional view taken along a line II-II′ of FIG. 10.

FIG. 12 is an exploded perspective view of a display apparatus according to an exemplary embodiment of the inventive concept.

FIG. 13A is a cross-sectional view taken along a line I-I′ of FIG. 12.

FIG. 13B is a cross-sectional view taken along a line II-II′ of FIG. 12.

FIG. 14 is an exploded perspective view of a display apparatus according to an exemplary embodiment of the inventive concept.

FIG. 15A is a cross-sectional view taken along a line I-I′ of FIG. 14.

FIG. 15B is a cross-sectional view taken along a line II-II′ of FIG. 14.

### DETAILED DESCRIPTION

Hereinafter, exemplary embodiments of the inventive concept will be explained in detail with reference to the accompanying drawings.

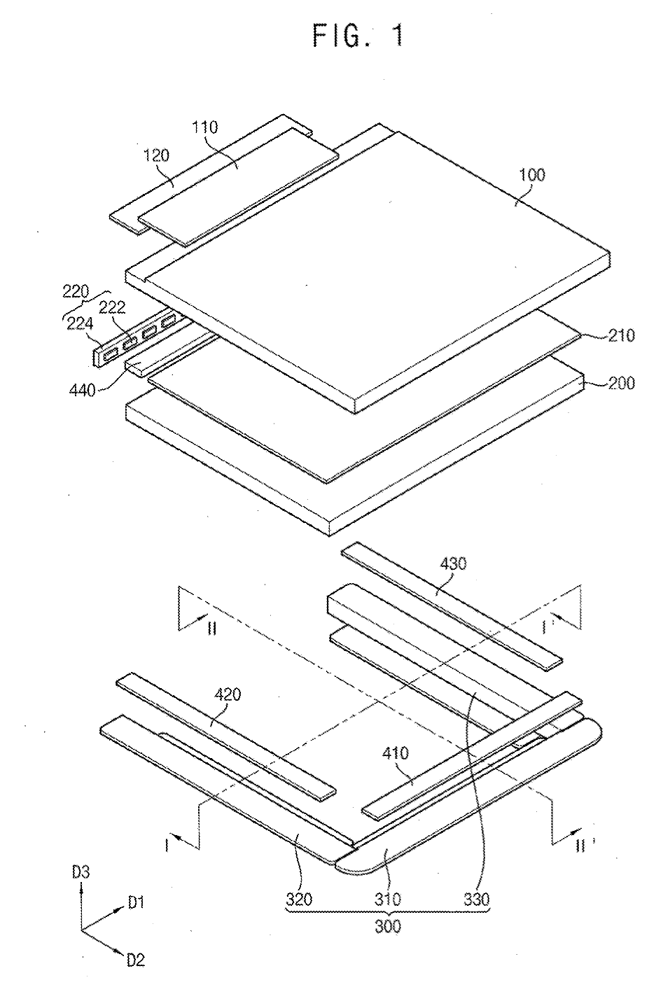

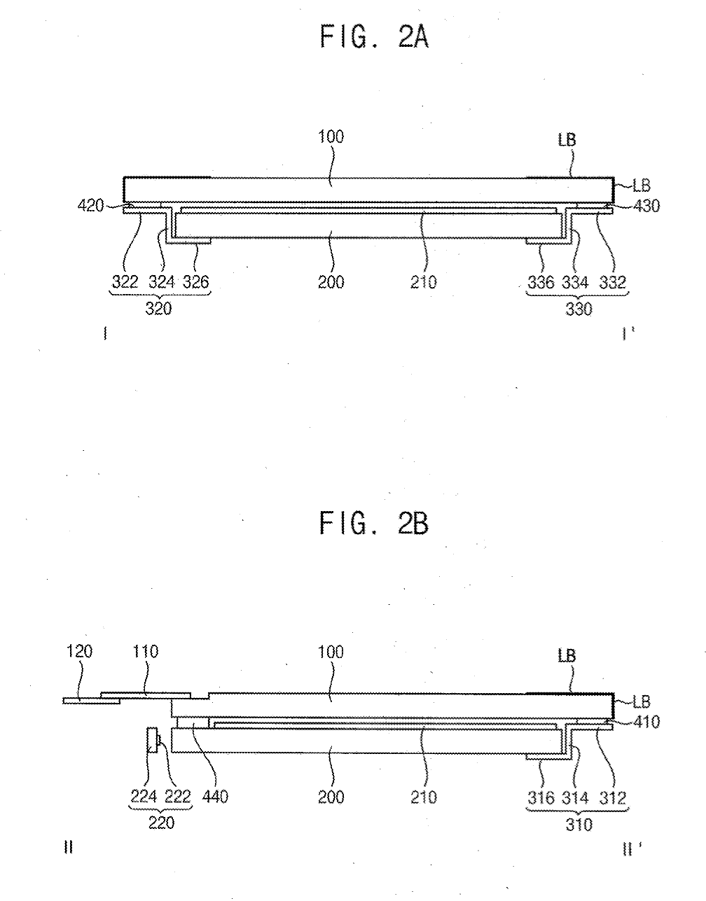

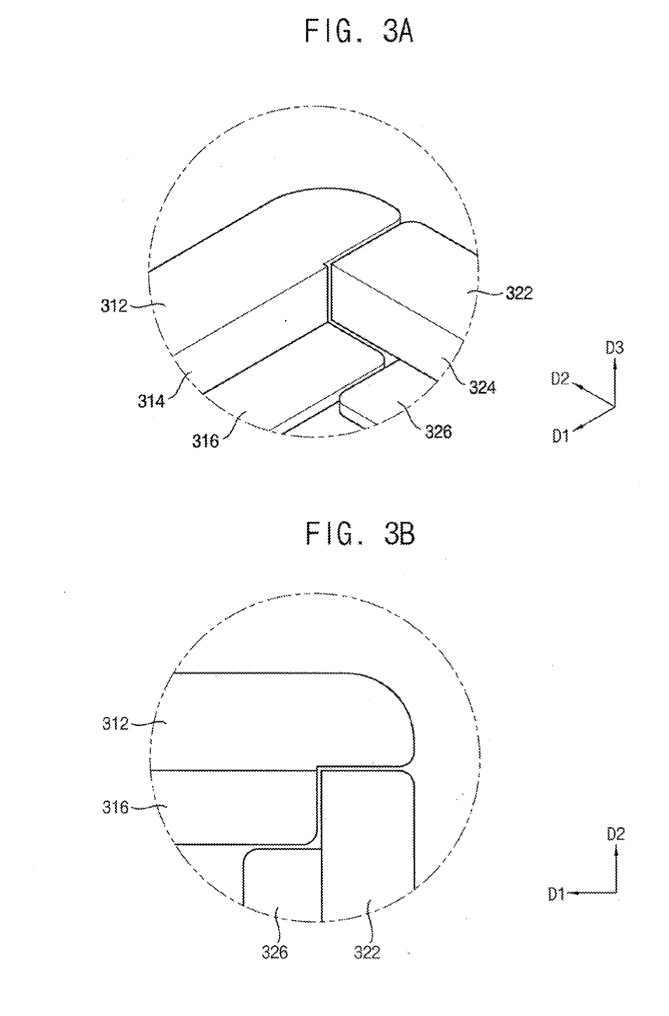

FIG. 1 is an exploded perspective view of a display apparatus according to an exemplary embodiment of the inventive concept. FIG. 2A is a cross-sectional view taken along a line I-I′ of FIG. 1. FIG. 2B is a cross-sectional view taken along a line II-II′ of FIG. 1. FIG. 3A is an enlarged perspective view of a portion of a support member of a display apparatus of FIG. 1. FIG. 3B is a plan view of a portion of a support member of FIG. 3A.

Referring to FIGS. 1, 2A, 2B, 3A and 3B, according to an exemplary embodiment, a display apparatus includes a display panel 100, a flexible film 110, a driving substrate 120, a light guide plate 200, an optical sheet 210, a light source unit 220, a support member 300 and an adhesive member.

Examples of the display panel 100 include an organic light emitting display panel, a liquid crystal display panel, an electrowetting display panel, an electrophoretic display panel, a MEMS (microelectromechanical system) display panel, a plasma display panel, etc.

According to an exemplary embodiment, the display panel 100 includes a liquid crystal display panel, which includes an array substrate, an opposing substrate that faces the array substrate, and a liquid crystal layer interposed between the array substrate and the opposing substrate. The array substrate includes a plurality of gate lines that extend in a first direction D1, a plurality of data lines intersecting with the gate lines and that extend in a second direction D2, a plurality of switching elements electrically connected to the gate lines and the data lines, and a plurality of pixel electrodes electrically connected to the switching elements. In addition, the array substrate or the opposing substrate further includes a common electrode that forms an electric field with the pixel electrodes. The display panel 100 has a first length in the first direction D1 greater than a second length in the second direction D2.

In another embodiment, the display panel 100 includes an organic electroluminescent display panel, which includes a plurality of organic electroluminescent structures that emit light. For example, each of the organic electroluminescent structures includes a first electrode, a second electrode that faces the first electrode, and an organic electroluminescent element interposed between the first electrode and the second electrode. The organic electroluminescent element includes a hole injection layer, a hole transfer layer, an organic light-emission layer, an electron transfer layer, an electro injection layer, etc.

According to an exemplary embodiment, a light blocking part LB is formed on an edge portion of an upper surface of the display panel 100. The light blocking part LB is a non-display area and is formed at a portion that overlaps the support member 300. In addition, the light blocking part LB may be formed on a side surface of the display panel 100.

According to an exemplary embodiment, the flexible film 110 is connects the driving substrate 120 to the display panel 100. The flexible film 110 transmits driving signals received from the driving substrate 120 to the display panel 100.

According to an exemplary embodiment, the driving substrate 120 includes a driving chip such as a timing controller that received input image data and generates driving signals that drive the display panel 100. For example, the driving substrate 120 receive input image data that includes red image data, green image data, and blue image data, and generates a master clock signal, a data enable signal, a vertical synchronizing signal, a horizontal synchronizing signal, etc.

According to an exemplary embodiment, the light guide plate 200 is disposed below the display panel 100. The light guide plate 200 guides light received from the light source unit 220 to the display panel 100. The light guide plate 200 includes a light incident surface on which the light is incident and a light exiting surface from which the light is emitted. The light incident surface of the light guide plate 200 faces the light source unit 220, and the light exiting surface of the light guide plate 200 faces the display panel 100. A quantum dot pattern that includes quantum dots or a quantum dot layer is formed on the light exiting surface of the light guide plate 200.

According to an exemplary embodiment, the quantum dot pattern or the quantum dot layer includes at least one quantum dot. A quantum dot is a nano-particle of a semiconductor material, which has a diameter no more than 100 nm. A quantum dot has a quantum confinement effect. Thus, a quantum dot can change a wavelength of light emitted by the light source.

In an exemplary embodiment, the quantum dot may include a II-VI group compound, a III-V group compound, a IV-VI group compound, a IV group element, a IV group compound or a combination thereof.

For example, according to an exemplary embodiment, the II-VI group compound may include a binary compound selected from CdSe, CdTe, ZnS, ZnSe, ZnTe, ZnO, HgS, HgSe, HgTe, MgSe, MgS, or a combination thereof, a ternary compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, or a combination thereof, or a quaternary compound selected from HgZnTeS, CdZnSeS, CdZnSeTe, CdZnSTe, CdHgSeS, CdHgSeTe, CdHgSTe, HgZnSeS, HgZnSeTe, HgZnSTe, or a combination thereof.

For example, according to an exemplary embodiment, the III-V group compound may include a binary compound selected from GaN, GaP, GaAs, GaSb, AlN, AlP, AlAs, AlSb, InN, InP, InAs, InSb, or a combination thereof, a ternary compound selected from GaNP, GaNAs, GaNSb, GaPAs, GaPSb, AlNP, AlNAs, AlNSb, AlPAs, AlPSb, InNP, InNAs, InNSb, InPAs, InPSb, GaAlNP, or a combination thereof, or a quaternary compound selected from GaAlNAs, GaAlNSb, GaAlPAs, GaAlPSb, GaInNP, GaInNAs, GaInNSb, GaInPAs, GaInNSb, InAlNP, InAlNAs, InAlNSb, InAlPAs, InAlPSb, or a combination thereof.

For example, according to an exemplary embodiment, the IV-VI group compound may include a binary compound selected from SnS, SnSe, SnTe, PbS, PbSe, PbTe, or a combination thereof, a ternary compound selected from SnSeS, SnSeTe, SnSTe, PbSeS, PbSeTe, PbSTe, SnPbS, SnPbSe, SnPbTe, or a combination thereof, or a quaternary compound selected from SnPbSSe, SnPbSeTe, SnPbSTe, or a combination thereof.

For example, according to an exemplary embodiment, the IV group element may include Si, Ge, or a combination thereof. The IV group compound may include a binary compound selected from SiC, SiGe, or a combination thereof.

According to an exemplary embodiment, the quantum dot has a core-shell structure that includes a core and a shell surrounding the core. The core and the shell may include different materials.

According to an exemplary embodiment, the quantum dot pattern or the quantum dot layer further include scattering particles to scatter incident light. For example, the scattering particle may include TiO2, Al2O3, SiO2 or a combination thereof.

According to an exemplary embodiment, the optical sheet 210 is disposed between the light guide plate 200 and the display panel 100. The optical sheet 210 may include a plurality of sheets to enhance characteristics of light from the light guide plate 200. For example, the optical sheet 210 may be a diffusing sheet.

According to an exemplary embodiment, the light source unit 220 includes a plurality of light sources 222 and a light source substrate 224. The light source unit 220 faces the light incident surface of the light guide plate 200. The light source unit 220 is disposed on one side of the light guide plate 200. For example, the light source unit 220 may be disposed adjacent to the light guide plate 200 in the second direction D2, and extend in the first direction D1. The plurality of light sources 222 of the light source unit 220 are a plurality of LEDs arranged in the first direction D1. The plurality of light sources 222 are mounted on the light source substrate 224.

According to an exemplary embodiment, the support member 300 includes a first support member 310, a second support member 320, and a third support member 330. The support member 300 supports and fixes the display panel 100 and the light guide plate 200.

According to an exemplary embodiment, the first support member 310 includes a first panel support portion 312, a first side wall 314, and a first light guide plate support portion 316.

According to an exemplary embodiment, the first panel support portion 312 extends in the first direction D1. The first panel support portion 312 is disposed parallel to the display panel 100 and supports an edge of a lower surface of the display panel 100. Thus, the first panel support portion 312 is disposed parallel to a plane formed by the first and second directions D1 and D2. The first panel support portion 312 overlaps the light blocking part LB. The first panel support portion 312 is fixed to the display panel 100 by an adhesive member that will be described below.

According to an exemplary embodiment, the first side wall 314 extends down from the first panel support portion 312 away from the display panel 100, that is, in a direction opposite to a third direction D3 perpendicular to the first and second directions D1 and D2. The first side wall 314 connects the first panel support portion 312 to the first light guide plate support portion 316. The first side wall 314 is disposed on a side surface of the light guide plate 200 and covers the side surface of the light guide plate 200.

According to an exemplary embodiment, the first light guide plate support portion 316 extends inward from the first side wall 314 and under the light guide plate 200. The first light guide plate support portion 316 supports an edge of a lower surface of the light guide plate 200. The first light guide plate support portion 316 is disposed parallel to the first panel support portion 312.

Accordingly, in an exemplary embodiment, the first support member 310 has a stepped shape, and the first support member 310 can be formed by bending a metal plate or by extruding the metal plate.

According to an exemplary embodiment, second support member 320 includes a second panel support portion 322, a second side wall 324, and a second light guide plate support portion 326.

According to an exemplary embodiment, the second panel support portion 322 extends in the second direction D2. The second panel support portion 322 is disposed parallel to the display panel 100 and supports an edge of the lower surface of the display panel 100. Thus, the second panel support portion 322 is disposed parallel to the plane formed by the first and second directions D1 and D2. The second panel support portion 322 overlaps the light blocking part LB. The second panel support portion 322 is fixed to the display panel 100 by an adhesive member that will be described below.

According to an exemplary embodiment, the second side wall 324 extends down from the second panel support portion 322 away from the display panel 100, that is, in a direction opposite to the third direction D3. The second side wall 324 connects the second panel support portion 322 to the second light guide plate support portion 326. The second side wall 324 is disposed on a side surface of the light guide plate 200 and covers the side surface of the light guide plate 200.

According to an exemplary embodiment, the second light guide plate support portion 326 extends inward from the second side wall 324 and under the light guide plate 200. The second light guide plate support portion 326 supports an edge of the lower surface of the light guide plate 200. The second light guide plate support portion 326 is disposed parallel to the second panel support portion 322.

Accordingly, in an exemplary embodiment, the second support member 320 has a stepped shape, and the second support member 320 can be formed by bending a metal plate or by extruding the metal plate.

According to an exemplary embodiment, the third support member 330 includes a third panel support portion 332, a third side wall 324, and a third light guide plate support portion 336.

According to an exemplary embodiment, the third panel support portion 332 extends in the second direction D2. The third panel support portion 322 is disposed parallel to the display panel 100 and supports an edge of the lower surface of the display panel 100. Thus, the third panel support portion 332 is disposed parallel to the plane formed by the first and second directions D1 and D2. The third panel support portion 332 overlaps the light blocking part LB. The third panel support portion 332 is fixed to the display panel 100 by an adhesive member that will be described below.

According to an exemplary embodiment, the third side wall 334 extends down from the third panel support portion 332 away from the display panel 100, that is, in a direction opposite to the third direction D3. The third side wall 334 connects the third panel support portion 332 to the third light guide plate support portion 336. The third side wall 334 is disposed on a side surface of the light guide plate 200 and covers the side surface of the light guide plate 200.

According to an exemplary embodiment, the third light guide plate support portion 336 extends inward from the third side wall 334 and under the light guide plate 200. The third light guide plate support portion 336 supports an edge of the lower surface of the light guide plate 200. The third light guide plate support portion 336 is disposed parallel to the third panel support portion 332.

Accordingly, in an exemplary embodiment, the third support member 330 has a stepped shape, and the third support member 330 can be formed by bending a metal plate or by extruding the metal plate.

According to an exemplary embodiment, the first, second, and third support members 310, 320, and 330 are disposed in a U-like pattern to support portions of three sides of the lower surface of the display panel 100. In addition, the first to third support members 310, 320, and 330 support portions of three sides of the lower surface of the light guide plate 200.

In addition, according to an exemplary embodiment, the light source unit 220 is disposed adjacent to a side of the display panel 100 where none of the first, second, and third support members 310, 320, and 330 are disposed. No additional support member is disposed between the light source unit 220 and the light guide plate 200 so that the light incident surface of the light guide plate 200 is exposed.

In addition, according to an exemplary embodiment, upper surfaces of the light guide plate 200 and inner surfaces of the first to third side walls 314, 324 and 334 are yellow. For example, when the support members are formed of a metal, a yellow layer is formed on the surface of the support members to provide the yellow color. For example, a yellow paint or a yellow film can be applied onto the surfaces.

According to an exemplary embodiment, when the display apparatus uses quantum dots, the light source unit 220 emits blue light. That is, blue light is used instead of white light as the light source of the display apparatus. Light leakage of the blue light can be reduced by the yellow surface of the support member 300.

Referring again to FIGS. 3A and 3B, the first panel support portion 312 of the first support member 310 is longer in the first direction D1 than the first light guide plate support portion 316 and the first side wall 314. The second panel support portion 322 and the second side wall 324 of the second support member 320 are longer in the second direction D2 than the second light guide plate support portion 326. At a corner portion of the display apparatus 200 the first support member and the second support member meet, the portions may have a stepped shape or a zigzag shape when viewed in a plan view. Referring to FIG. 3B, it can be seen that portions where the first support member 310 and the second support member 320 meet have a stepped shape or a zigzag shape when viewed in a plan view. Accordingly, at the corner portion, it is possible to prevent light emitted from the light source unit 220 from leaking out of the display apparatus at the portion where the first support member 310 and the second support member 320 meet.

According to a conventional display apparatus, a structure that includes a mold frame, an upper chassis and a lower chassis is used to support internal structures, such as the display panel and the light guide plate, of the display apparatus. However, according to a present embodiment, the display panel 100, the light guide plate 200 and the optical sheet 210 therebetween can be supported and fixed by the support member 300. Thus, a display apparatus can be slim and have a simplified structure.

Referring again to FIG. 1, according to an exemplary embodiment, the adhesive member includes a first adhesive member 410, a second adhesive member 420, a third adhesive member 430, and a first light guide plate adhesive member 440.

According to an exemplary embodiment, the first adhesive member 410 is disposed between the display panel 100 and the first panel support portion 312 of the first support member 310, and is attached the edge of the lower surface of the display panel 100 and the first panel support portion 312. The first adhesive member 410 may be a double-sided tape, a foam tape, etc. The first adhesive member 410 has a first thickness.

According to an exemplary embodiment, the second adhesive member 420 is disposed between the display panel 100 and the second panel support portion 322 of the second support member 320, and is attached to the edge of the lower surface of the display panel 100 and the second panel support portion 322. The second adhesive member 420 may be a double-sided tape, a foam tape, etc. The second adhesive member 420 has the same first thickness as the first adhesive member 410.

According to an exemplary embodiment, the third adhesive member 430 is disposed between the display panel 100 and the third panel support portion 332 of the third support member 330, and is attached to the edge of the lower surface of the display panel 100 and the third panel support portion 332. The third adhesive member 430 may be a double-sided tape, a foam tape, etc. The third adhesive member 430 has the same first thickness as the first and second adhesive members 410, 420.

According to an exemplary embodiment, the first light guide plate adhesive member 440 is disposed adjacent to the light source unit 220 between the edge of the upper surface of the light guide plate 200 and the edge of the lower surface of the display panel 200, and is attached to the edge of the lower surface of the display panel 100 and the light guide plate 200. The first light guide plate adhesive member 440 is directly positioned between the light guide plate 200 and the display panel 100 to fixed them to each other. The first light guide plate adhesive member 440 has a second thickness. Since a distance from the upper surface of the light guide plate 200 to the lower surface of the display panel may differ from a distance between the panel support portions 312, 322, 342 of the support member 300 and the lower surface of the display panel 100, the second thickness may differ from the first thickness. FIG. 2B shows a case where the second thickness is greater than the first thickness.

In addition, according to an exemplary embodiment, although the optical sheet 210 and the display panel 100 are shown as being separated from each other in FIG. 2B, they may be in contact with each other as needed in other embodiments.

In addition, according to an exemplary embodiment, an additional adhesive member, such as a double-sided tape or a foam tape, may be further disposed between an edge portion of the lower surface of the light guide plate 200 and the light guide plate support portions 316, 326 and 336 of the support member 300, so that the light guide plate 200 can be fixed to the support member 300.

According to a present embodiment, a display apparatus includes a display panel, a light guide plate, and a support member, and the light guide plate can be simply supported and fixed by the support member. Thus, the thickness of the display apparatus can be reduced, and the structure can be simplified.

In addition, according to an exemplary embodiment, a display apparatus uses quantum dots, and in this case, the light source unit emits blue light. Here, unwanted light leakage of the blue light can be reduced by the yellow surface of the support member.

In addition, according to an exemplary embodiment, a support member of a display apparatus includes first and second support members, and portions where the first support member and the second support member meet have a stepped shape or a zigzag shape when viewed in a plan view.

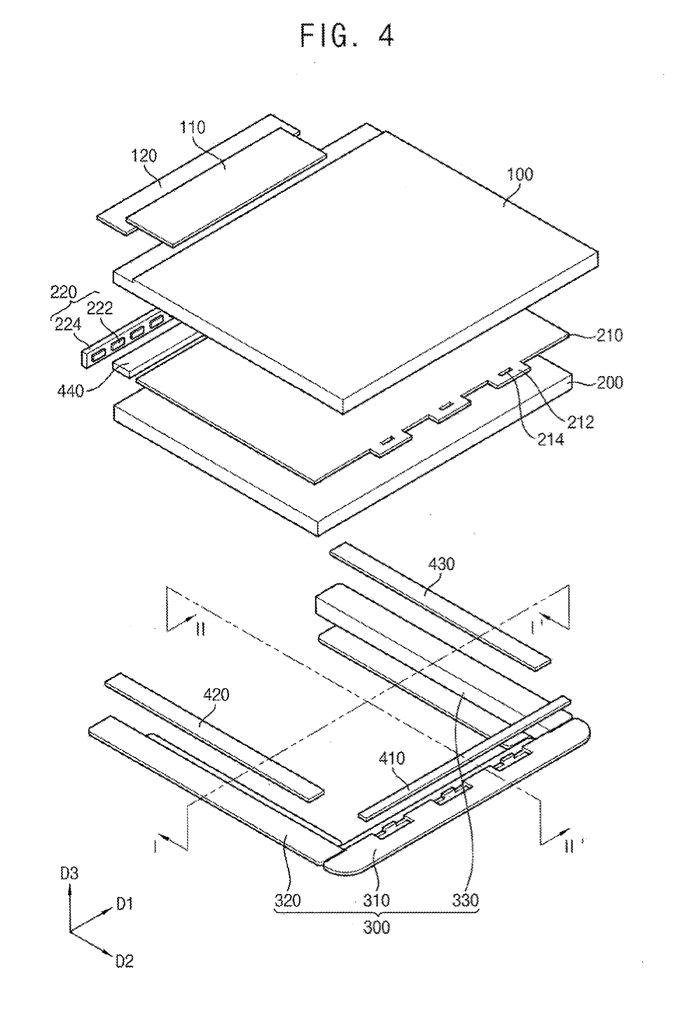

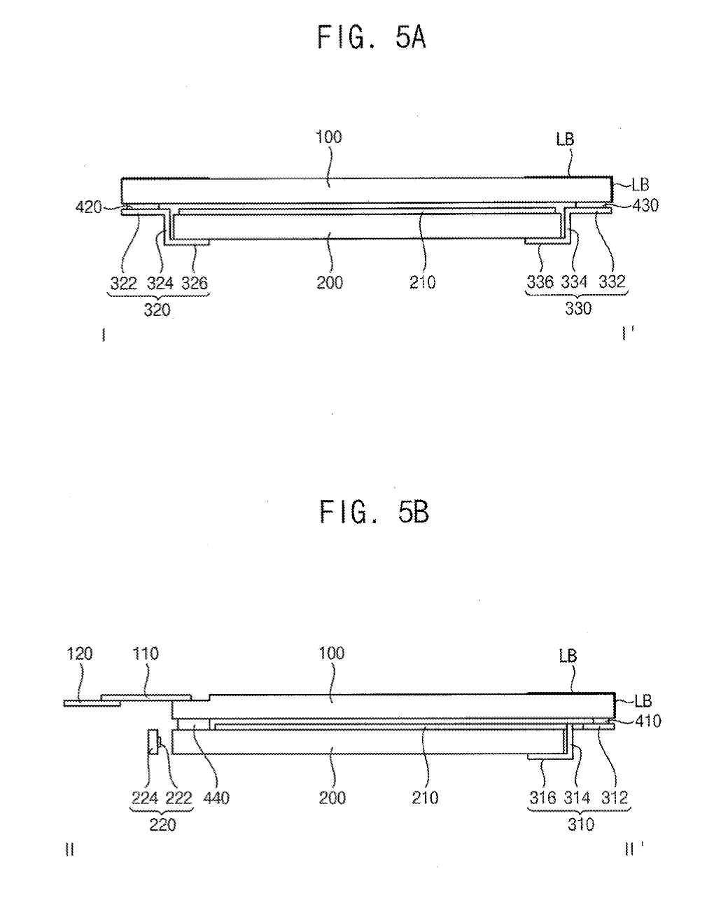

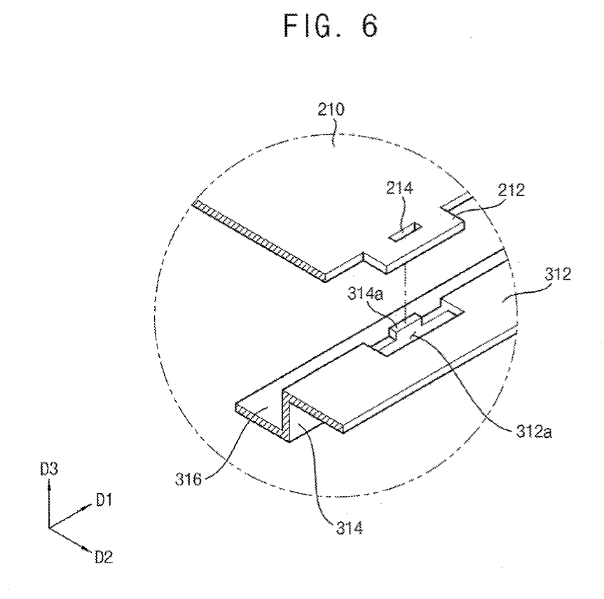

FIG. 4 is an exploded perspective view of a display apparatus according to an exemplary embodiment of the inventive concept. FIG. 5A is a cross-sectional view taken along a line I-I′ of FIG. 4. FIG. 5B is a cross-sectional view taken along a line II-II′ of FIG. 4. FIG. 6 is an enlarged exploded perspective view of a combined structure of an optical sheet and a support member of a display apparatus of FIG. 4.

Referring to FIGS. 4, 5A, 5B and 6, according to an exemplary embodiment, a display apparatus is substantially the same as a display apparatus of FIGS. 1 to 3B except that sheet holders 314a a reformed on a first support member 310 and protrusions 212 with openings 214 are formed on the optical sheet 210. Therefore, a repetitive description will be summarized or omitted.

According to an exemplary embodiment, the display apparatus includes a display panel 100, a flexible film 110, a driving substrate 120, a light guide plate 200, an optical sheet 210, a light source unit 220, a support member 300 and an adhesive member.

According to an exemplary embodiment, a light blocking part LB is formed on an edge portion of an upper surface of the display panel 100. The flexible film 110 connects the driving substrate 120 to the display panel 100. The light guide plate 200 is disposed under the display panel 100. The optical sheet 210 is disposed between the light guide plate 200 and the display panel 100.

According to an exemplary embodiment, each protrusion 212 protrudes from one side of the optical sheet 210. The protrusions 212 protrude in the second direction D2 from the one side of the optical sheet 210, and are formed in the same plane as the optical sheet 210. Each opening 214 is formed in each protrusion 212 and a sheet hook 314a of a first support member 310 to be described below is inserted into the opening 214 to fix the optical sheet 210. Accordingly, the optical sheet 210 can be properly positioned without an additional member, and a manufacturing process of a display apparatus can be simplified, and the efficiency can be improved.

According to an exemplary embodiment, the light source unit 220 includes a plurality of light sources 222 and a light source substrate 224. The support member 300 includes a first support member 310, a second support member 320, and a third support member 330. The adhesive member includes a first adhesive member 410, a second adhesive member 420 and a third adhesive member 430 and a first light guide plate adhesive member 440.

According to an exemplary embodiment, the first support member 310 includes a first panel support portion 312, a first side wall 314, and a first light guide plate support portion 316. The second support member 320 includes a second panel support portion 322, a second side wall 324, and a second light guide plate support portion 326. The third support member 330 includes a third panel support portion 332, a third side wall 324, and a third light guide plate support portion 336.

According to an exemplary embodiment, the first panel support portion 312 includes a plurality of sheet hook openings 312a. Each protrusion 212 of the optical sheet 210 is received in the corresponding sheet hook opening 312a.

According to an exemplary embodiment, the sheet hooks 314a protrud in the third direction D3 and are formed on the first side wall 314. The sheet hooks 314a are adjacent to the sheet hook openings 312a of the first panel support portion 312, and are a portion of the first side wall 314.

According to an exemplary embodiment, the first light guide plate support portion 316 extends inward from the first side wall 334 to the light guide plate 200.

Accordingly, in an exemplary embodiment, the first support member 310 has a stepped shape, and the first support member 310 can be formed by bending a metal plate or by extruding the metal plate. In particular, when the first support member 310 is formed by bending a metal plate, the sheet hook opening 312a is formed in the metal plate, and then the metal plate is bent to form the sheet hook 314a relatively simply.

According to a present embodiment, since the protrusion 212 of the optical sheet 210 is fixed by the sheet hook 314a, the optical sheet 210 can be correctly positioned without an additional member, which simplifies a manufacturing process of the display apparatus and improves the efficiency.

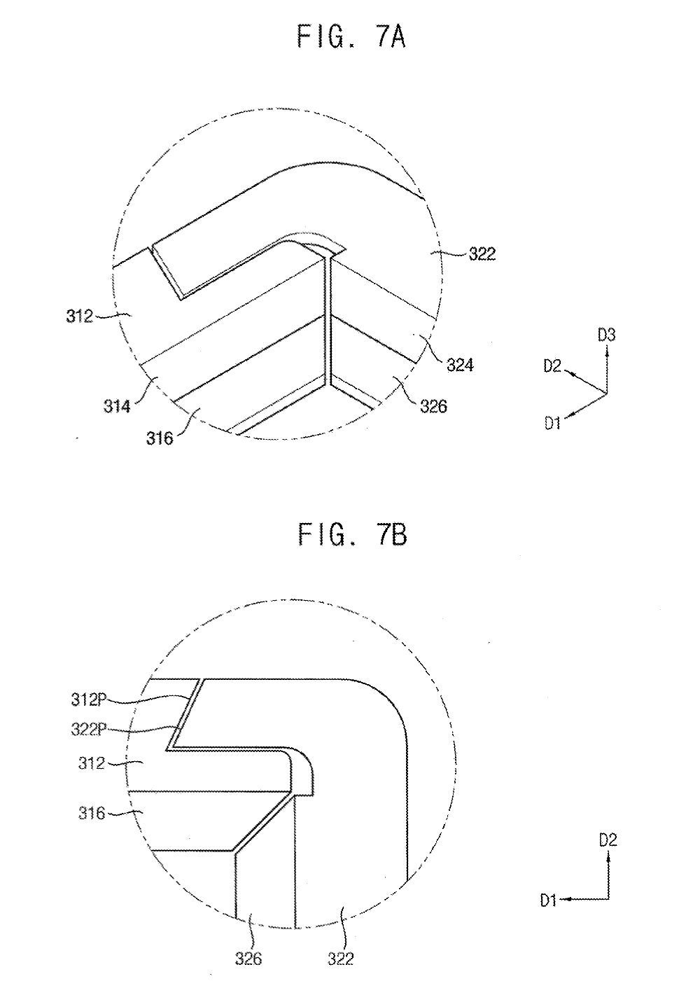

FIG. 7A is an enlarged perspective view of a portion of a support member of a display apparatus according to an exemplary embodiment of the inventive concept. FIG. 7B is a plan view of the portion of a support member of FIG. 7A.

Referring to FIGS. 7A and 7B, according to an exemplary embodiment, a recessed portion 312P is formed at an end of the first panel support portion 312 of the first support member 310. A protrusion 322P that protrudes in the first direction D1 is formed at an end of a second panel support portion 322 of the second support member 320. The protrusion 322P of the second panel support portion 322 is received in the recessed portion 312P of the first panel support portion 312, so that portions where the first support member and the second support member meet have a stepped shape or a zigzag shape when viewed in a plan view. Accordingly, at a corner portion of the display apparatus where the first support member 310 and the second support member 320 meet, it is possible to prevent light emitted from a light source unit from leaking out of the display apparatus.

That is, according to an exemplary embodiment, the portions where the first support member and the second support member meet have a stepped shape or a zigzag shape when viewed in a plan view. FIGS. 7A and 7B show an embodiment different from FIGS. 3A and 3B.

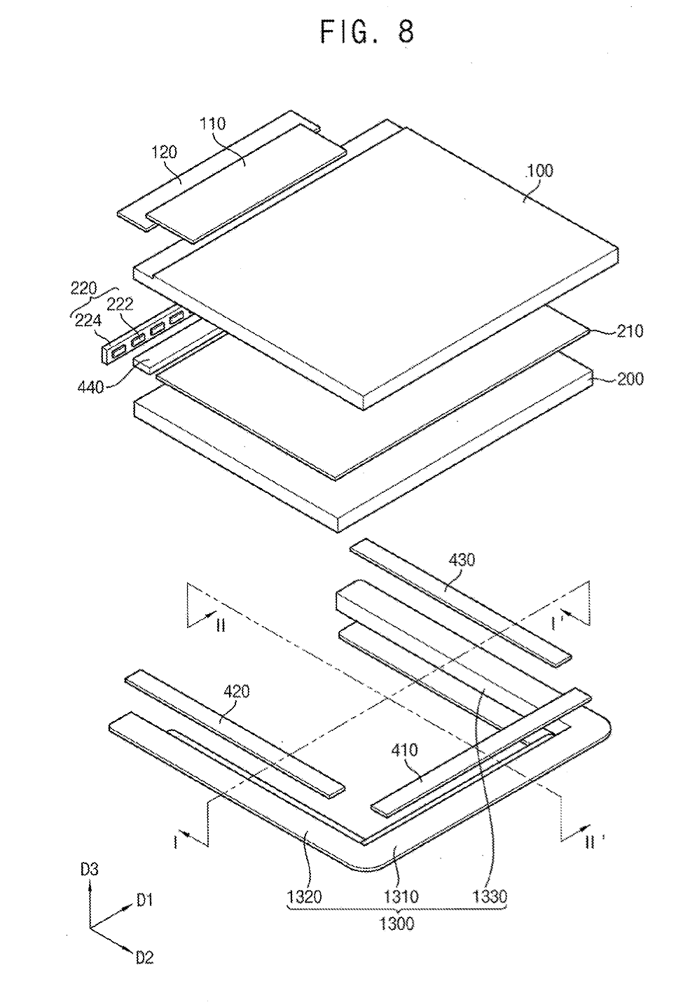

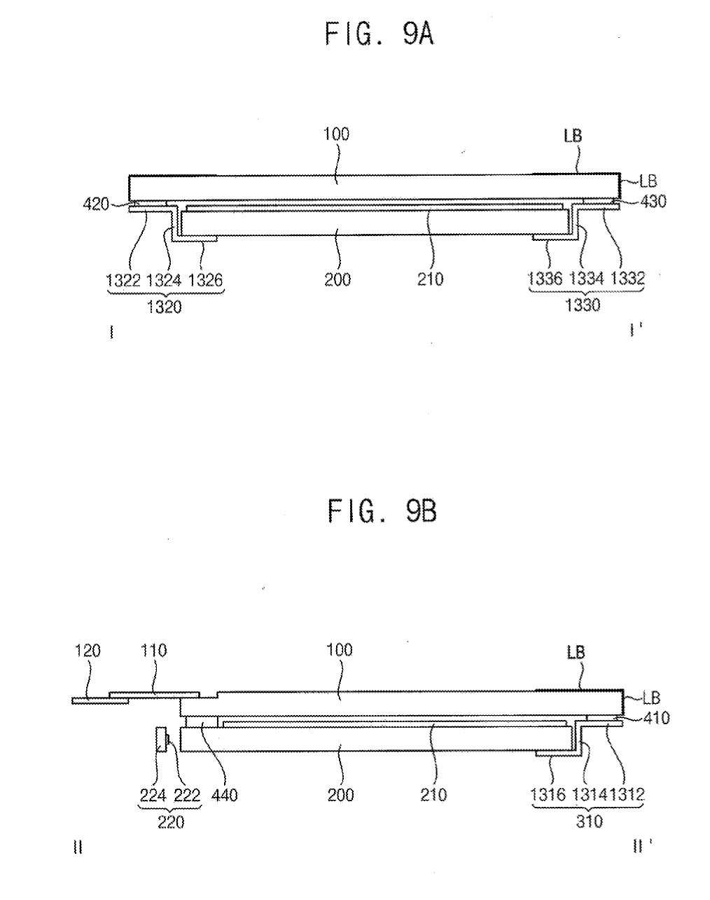

FIG. 8 is an exploded perspective view of a display apparatus according to an exemplary embodiment of the inventive concept. FIG. 9A is a cross-sectional view taken along a line I-I′ of FIG. 8. FIG. 9B is a cross-sectional view taken along a line II-II′ of FIG. 8.

Referring to FIGS. 8, 9A and 9B, according to an exemplary embodiment, a display apparatus may be substantially the same as a display apparatus of FIGS. 1 to 3B, except that first to third support members are integrally formed as one component. Therefore, a repetitive description will be summarized or omitted.

According to an exemplary embodiment, a display apparatus includes a display panel 100, a flexible film 110, a driving substrate 120, a light guide plate 200, an optical sheet 210, a light source unit 220, a support member 1300 and an adhesive member.

According to an exemplary embodiment, a light blocking part LB is formed on an edge portion of an upper surface of the display panel 100. The flexible film 110 connects the driving substrate 120 to the display panel 100. The light guide plate 200 is disposed under the display panel 100. The optical sheet 210 is disposed between the light guide plate 200 and the display panel 100.

According to an exemplary embodiment, the light source unit 220 includes a plurality of light sources 222 and a light source substrate 224. The support member 1300 includes a first support member 1310, a second support member 1320, and a third support member 1330.

According to an exemplary embodiment, the first support member 1310 includes a first panel support portion 1312, a first side wall 1314, and a first light guide plate support portion 1316. The second support member 1320 includes a second panel support portion 1322, a second side wall 1324, and a second light guide plate support portion 1326. The third support member 1330 includes a third panel support portion 1332, a third side wall 1324, and a third light guide plate support portion 1336.

According to an exemplary embodiment, the adhesive member includes a first adhesive member 410, a second adhesive member 420, a third adhesive member 430, and a first light guide plate adhesive member 440.

According to an exemplary embodiment, the first to third support members 1310, 1320, and 1330 are integrally formed as one component. Accordingly, the support member 1300 is integrally formed as one component, and has a C-shape. Therefore, light leakage at a corner of the display apparatus can be prevented.

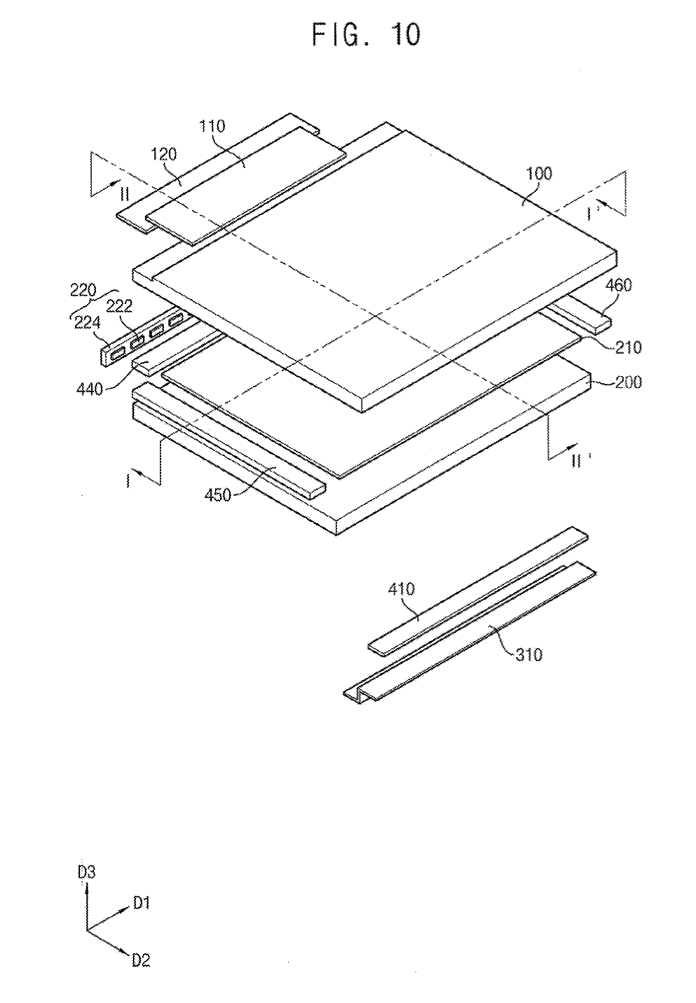

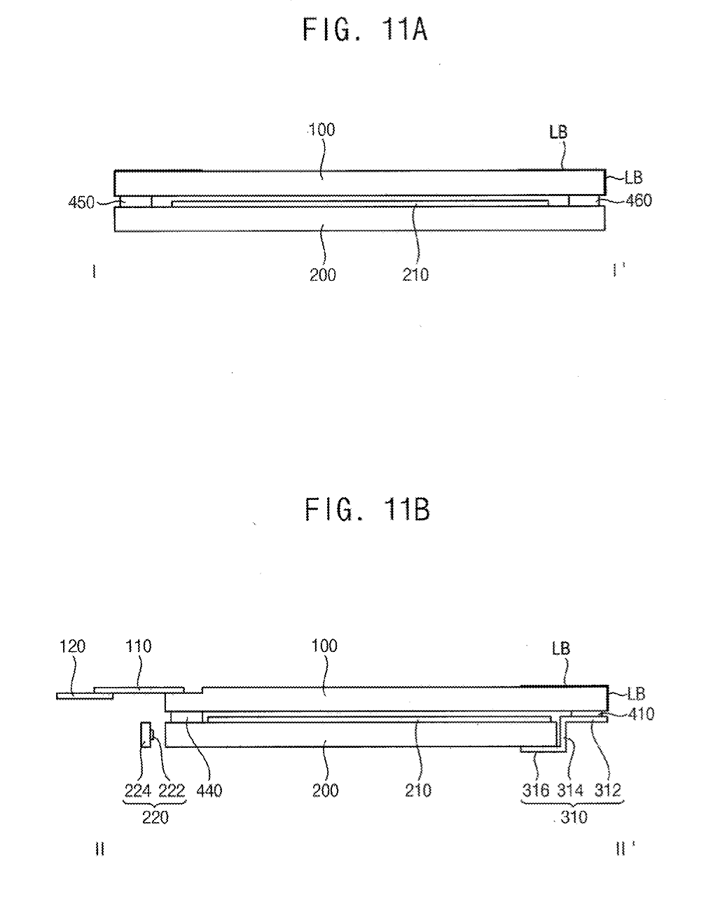

FIG. 10 is an exploded perspective view of a display apparatus according to an exemplary embodiment of the inventive concept. FIG. 11A is a cross-sectional view taken along a line I-I′ of FIG. 10. FIG. 11B is a cross-sectional view taken along a line II-II′ of FIG. 10.

Referring to FIGS. 10, 11A and 11B, according to an exemplary embodiment, a display apparatus is substantially the same as a display apparatus of FIGS. 1 to 3B except that second and third light guide plate adhesive members replace the second and third support members. Therefore, a repetitive description will be summarized or omitted.

According to an exemplary embodiment, a display apparatus includes a display panel 100, a flexible film 110, a driving substrate 120, a light guide plate 200, an optical sheet 210, a light source unit 220, a first support member 310 and an adhesive member.

According to an exemplary embodiment, a light blocking part LB is formed on an edge portion of an upper surface of the display panel 100. The flexible film 110 connects the driving substrate 120 to the display panel 100. The light guide plate 200 is disposed under the display panel 100. The optical sheet 210 is disposed between the light guide plate 200 and the display panel 100. The light source unit 220 includes a plurality of light sources 222 and a light source substrate 224. The adhesive member includes a first adhesive member 410, a first light guide plate adhesive member 440, a second light guide plate adhesive member 450 and the third light guide plate adhesive member 460.

According to an exemplary embodiment, the first support member 310 include a first panel support portion 312, a first side wall 314, and a first light guide plate support portion 316.

According to an exemplary embodiment, the light source unit 220 is disposed adjacent to a first side of the display panel 100, and the second light guide plate adhesive member 450 and the third light guide plate adhesive member 460 are respectively disposed adjacent to third and fourth sides of the display panel 100 that are perpendicular to the first side and a second side of the display panel 100.

According to an exemplary embodiment, the second light guide plate adhesive member 450 and the third light guide plate adhesive member 460 are each disposed between the light guide plate 200 and the display panel 100, and are attached to the light guide plate 200 and the display panel 100.

According to an exemplary embodiment, a display apparatus according to a present embodiment has a structure in which the second and third support members are omitted, and are replaced by the second and third light guide plate adhesive members, respectively. Accordingly, since the second and third support members are not required, a manufacturing process is simplified and efficiency is increased. A display apparatus has a simple structure that can reduce cost, and has a narrower left and right bezel while being fixed by the single first support member.

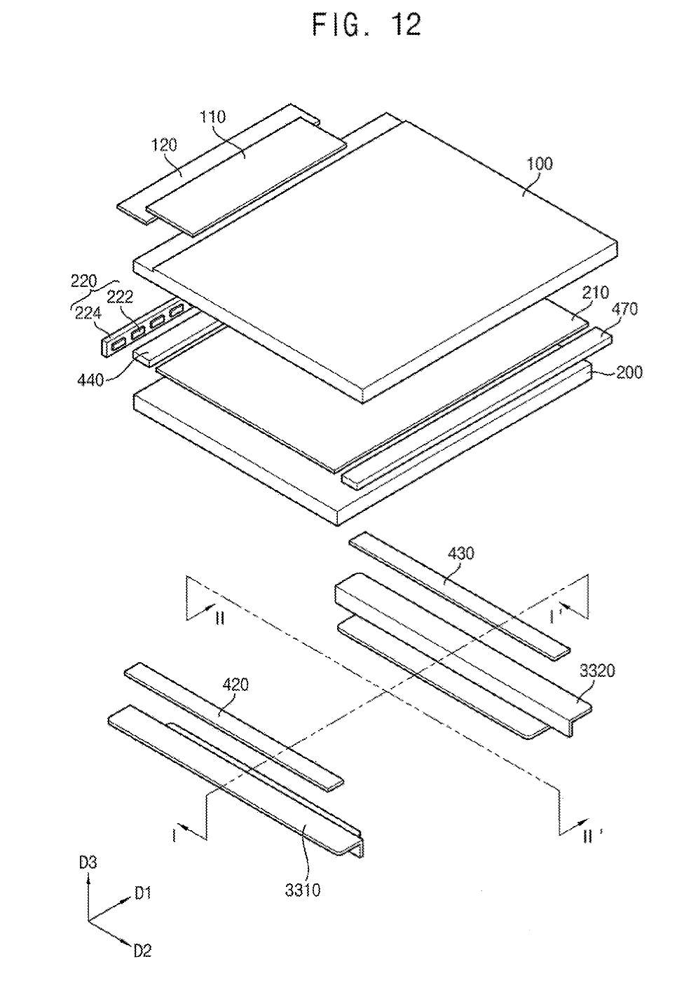

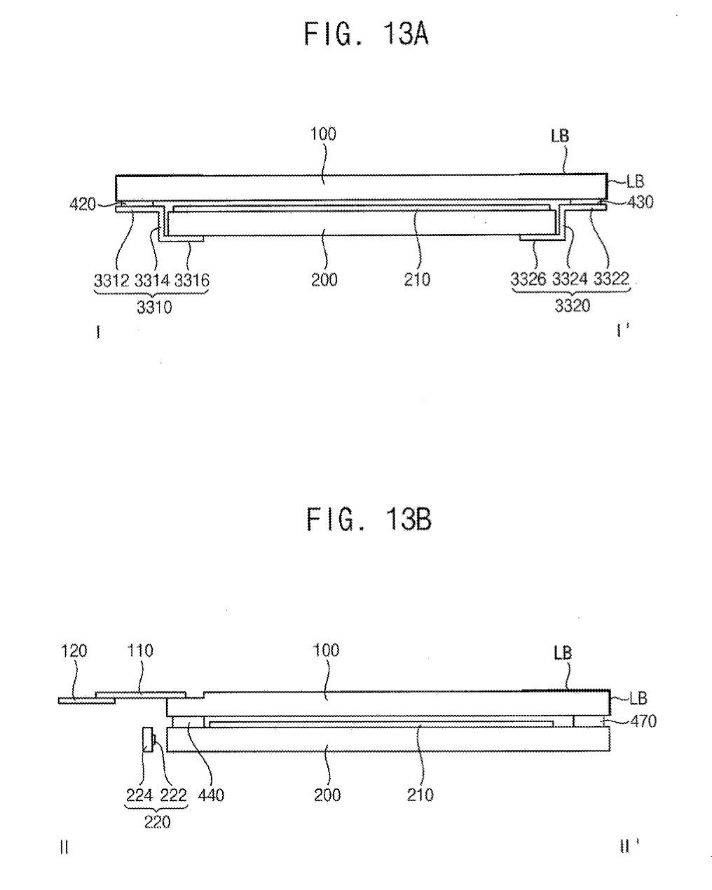

FIG. 12 is an exploded perspective view of a display apparatus according to an exemplary embodiment of the inventive concept. FIG. 13A is a cross-sectional view taken along a line I-I′ of FIG. 12. FIG. 13B is a cross-sectional view taken along a line II-II′ of FIG.

Referring to FIGS. 12, 13A and 13B, according to an exemplary embodiment, a display apparatus is substantially the same as a display apparatus of FIGS. 1 to 3B except that a second light guide plate adhesive member replaces a first support member. Therefore, a repetitive description will be summarized or omitted.

According to an exemplary embodiment, a display apparatus includes a display panel 100, a flexible film 110, a driving substrate 120, a light guide plate 200, an optical sheet 210, a light source unit 220, a first support member 3310, a second support member 3320, and an adhesive member.

According to an exemplary embodiment, a light blocking part LB is formed on an edge portion of an upper surface of the display panel 100. The flexible film 110 connects the driving substrate 120 to the display panel 100. The light guide plate 200 is disposed under the display panel 100. The optical sheet 210 is disposed between the light guide plate 200 and the display panel 100. The light source unit 220 includes a plurality of light sources 222 and a light source substrate 224. The adhesive member includes a second adhesive member 420, a third adhesive member 430, a first light guide plate adhesive member 440 and a second light guide plate adhesive member 470.

According to an exemplary embodiment, the first support member 3310 includes a first panel support portion 3312, a first side wall 3314, and a first light guide plate support portion 3316. The second support member 3320 includes a second panel support portion 3322, a second side wall 3324, and a second light guide plate support portion 3326.

According to an exemplary embodiment, the light source unit 220 is disposed adjacent to a first side of the display panel 100, and the second light guide plate adhesive member 470 is disposed adjacent to a second side of the display panel 100 opposite to the first side.

According to an exemplary embodiment, the second light guide plate adhesive member 470 is disposed between the light guide plate 200 and the display panel 100, and is attached to the light guide plate 200 and the display panel 100.

A display apparatus according to a present embodiment has a structure in which the first support member is omitted and is replaced by the second light guide plate adhesive member.

Accordingly, a manufacturing process is simplified and efficiency is improved, the display apparatus has a simple structure that can reduce the cost. One side of the display apparatus can be realized with a narrower bezel.

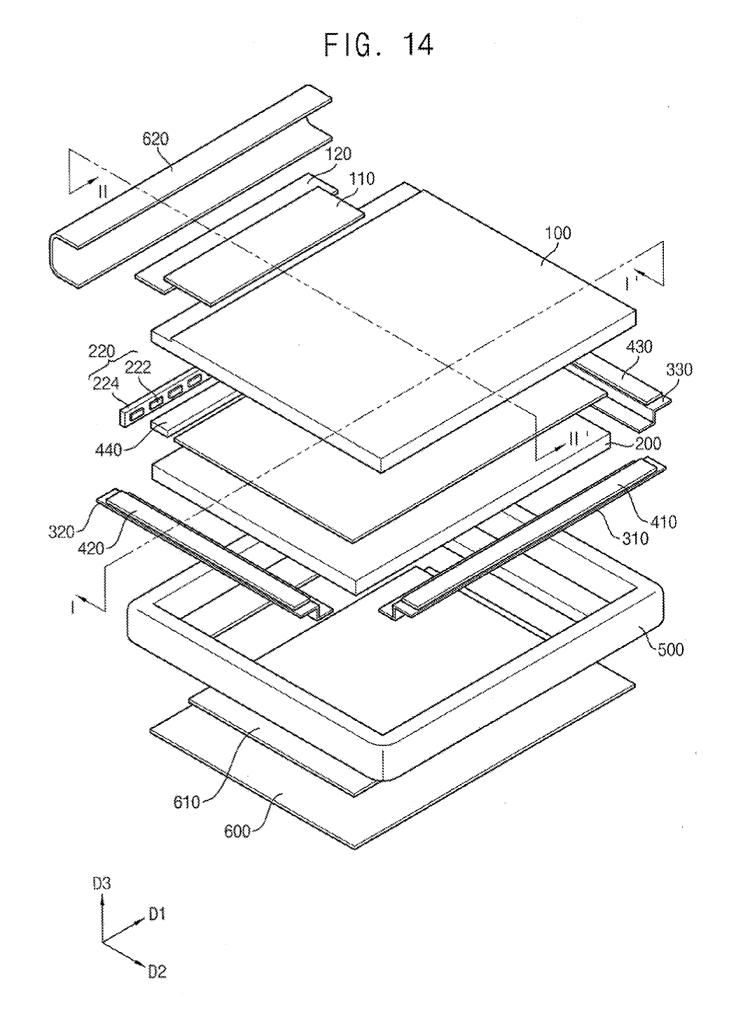

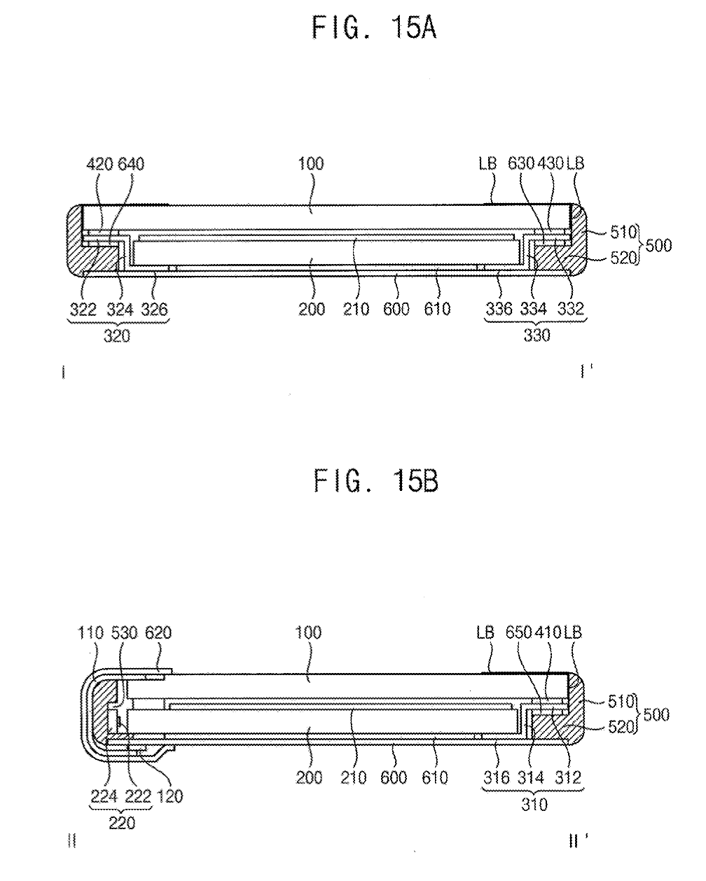

FIG. 14 is an exploded perspective view of a display apparatus according to an exemplary embodiment of the inventive concept. FIG. 15A is a cross-sectional view taken along a line I-I′ of FIG. 14. FIG. 15B is a cross-sectional view taken along a line II-II′ of FIG. 14.

Referring to FIGS. 14, 15A and 15B, according to an exemplary embodiment, a display apparatus of FIGS. 1 to 3B is incorporated into an end product, and is substantially similar to the display apparatus of FIGS. 1 to 3B except that the display apparatus further includes a frame 500, a back plate 600, a reflecting plate 610, and a cover 620. Therefore, a repetitive description will be summarized or omitted.

According to an exemplary embodiment, a display apparatus includes a display panel 100, a flexible film 110, a driving substrate 120, a light guide plate 200, an optical sheet 210, a light source unit 220, a support member 300, an adhesive member, the frame 500, the back plate 600, the reflecting plate 610, and the cover 620.

According to an exemplary embodiment, a light blocking part LB is formed on an edge portion of an upper surface of the display panel 100. The flexible film 110 connects the driving substrate 120 to the display panel 100. The light guide plate 200 is disposed under the display panel 100. The optical sheet 210 is disposed between the light guide plate 200 and the display panel 100. The light source unit 220 includes a plurality of light sources 222 and a light source substrate 224. The support member 300 includes a first support member 310, a second support member 320, and a third support member 330. The adhesive member includes a first adhesive member 410, a second adhesive member 420, a third adhesive member 430 and a first light guide plate adhesive member 440.

According to an exemplary embodiment, the first support member 310 includes a first panel support portion 312, a first side wall 314, and a first light guide plate support portion 316. The second support member 320 includes a second panel support portion 322, a second side wall 324, and a second light guide plate support portion 326. The third support member 330 includes a third panel support portion 332, a third side wall 324, and a third light guide plate support portion 336.

According to an exemplary embodiment, the frame 500 receives a combined structure of the display panel 100, the light guide plate 200, the support member 300, and the light source unit 220. Specifically, the frame 500 includes a support portion 520 that seats the support member 300, and a body 510 that forms an outer periphery of the display apparatus. The panel support portions 312, 322, and 332 of the support member are seated on the support portion 520. A light source receiving portion 530 is formed inside the frame 500 that receives that the light source unit 220.

According to an exemplary embodiment, the back plate 600 is fixed to the frame 500 and covers a lower surface of the light guide plate 200.

According to an exemplary embodiment, the reflecting plate 610 is disposed between the back plate 600 and the light guide plate 200, and reflects light. Accordingly, light emitted from the light guide plate 200 to an opposite side of the display panel 100 is reflected upward by the reflecting plate 610 toward the display panel 100.

According to an exemplary embodiment, the flexible film 110 is bent so that the driving substrate 120 can be positioned on a lower surface of the display apparatus, and the cover 620 covers the flexible film 110 and the driving substrate 120.

On the other hand, the support member 300 may be fixed to the frame 500 by additional adhesive members 630, 640 and 650.

A display apparatus according to an exemplary embodiment shown in FIG. 14 includes the frame and the back plate, and a front surface of the display panel is exposed, so that it can be utilized in a final product, such as a TV or a monitor.

According to a present embodiment, a display apparatus includes a display panel, a light guide plate, and a support member, and the display panel and the light guide plate can be simply supported and fixed by the support member. Thus, a thickness of the display apparatus can be reduced, and the structure can be simplified.

In addition, a display apparatus according to an exemplary embodiment uses quantum dots, and in this case, the light source unit emits blue light. Here, unwanted light leakage of the blue light can be reduced due to the yellow surface of the support member.

In addition, According to an exemplary embodiment, a support member of a display apparatus includes first and second support members, and portions where the first support member and the second support member meet have a stepped shape or a zigzag shape when viewed in a plan view to prevent light leakage at the corner portion of the display apparatus.

In addition, according to an exemplary embodiment, a display apparatus further includes an optical sheet that has protrusions formed thereon. Since the protrusions of the optical sheet are fixed by sheet hooks of the support member, the optical sheet can be correctly positioned without an additional member, so that a manufacturing process of the display apparatus can be simplified, and the efficiency can be improved.

In addition, according to an exemplary embodiment, a support member can be integrally formed, thereby improving the light leakage blocking effect.

In addition, according to an exemplary embodiment, a support member of a display apparatus may be disposed on only one side or both sides of the display apparatus and may be replaced with a light guide plate adhesive member. Accordingly, a structure of a display apparatus can be further simplified, the manufacturing process can be further simplified, and the efficiency can be further improved. Further, a bezel width can be further reduced.

The foregoing is illustrative of embodiments of the inventive concept and is not to be construed as limiting thereof. Although a few exemplary embodiments of the inventive concept have been described, those skilled in the art will readily appreciate that many modifications are possible in the exemplary embodiments without materially departing from the novel teachings and advantages of the inventive concept. Therefore, it is to be understood that the foregoing is illustrative of embodiments of the inventive concept and is not to be construed as limited to the specific exemplary embodiments disclosed, and that modifications to the disclosed exemplary embodiments, as well as other exemplary embodiments, are intended to be included within the scope of the appended claims. Embodiments of the inventive concept are defined by the following claims, with equivalents of the claims to be included therein.

What is claimed is:

1. A display apparatus, comprising:
a display panel;
a light guide plate disposed under the display panel and that includes a light incident surface and a light exit surface;
a light source unit that faces the light incident surface of the light guide plate;
a first support member that includes a first panel support portion disposed parallel to the display panel, a first light guide plate support portion disposed parallel to the first panel support portion, and a first side wall that connects the first light guide plate support portion to the first panel support portion and extends in a direction perpendicular to the first panel support portion;
a first adhesive member disposed between the first panel support portion and the display panel, and that is attached to the first panel support portion and the display panel; and
a first light guide plate adhesive member disposed adjacent to the light incident surface of the light guide plate between the light guide plate and the display panel, and that is attached to the light guide plate and the display panel.

2. The display apparatus of claim 1, wherein the light source unit is disposed adjacent to a first side of the display panel, and the first support member is disposed adjacent to a second side of the display panel opposite to the first side.

3. The display apparatus of claim 2, further comprising second and third light guide plate adhesive members that are disposed adjacent to third and fourth sides of the display panel, respectively, wherein the third and fourth sides are perpendicular to the first and second sides, and
wherein each of the second light guide plate adhesive member and the third light guide plate adhesive member is disposed between the light guide plate and the display panel, and is attached to the light guide plate and the display panel.

4. The display apparatus of claim 2, further comprising:
a second support member that includes a second panel support portion disposed parallel to the display panel, a second light guide plate support portion disposed parallel to the second panel support portion, and a second side wall that connects the second light guide plate support portion to the second panel support portion and extends in a direction perpendicular to the second panel support portion; and
a third support member that includes a third panel support portion disposed parallel to the display panel, a third light guide plate support portion disposed parallel to the third panel support portion, and a third side wall that connects the third light guide plate support portion to the third panel support portion and extends in a direction perpendicular to the third panel support portion, and
wherein the second support member and the third support member are disposed adjacent to third and fourth sides of the display panel, wherein the third and fourth sides connect the first side to the second side.

5. The display apparatus of claim 4, further comprising:
a second adhesive member disposed between the second panel support portion and the display panel and that is attached to the second panel support portion and the display panel; and
a third adhesive member disposed between the third panel support portion and the display panel and that is attached to the third panel support portion and the display panel.

6. The display apparatus of claim 5, wherein the first to third support members are integrally formed as one component, and have a C-shape.

7. The display apparatus of claim 5, wherein portions where the first support member and the second support member meet have a stepped shape or a zigzag shape when viewed in a plan view.

8. The display apparatus of claim 5, further comprising an optical sheet disposed between the light guide plate and the display panel,
wherein a protrusion protrudes from a side of the optical sheet, an opening is formed at the protrusion, and
a sheet hook is formed on the first support member, and the sheet hook is inserted into the opening.

9. The display apparatus of claim 8, wherein a sheet hook opening is formed in the first panel support portion of the first support member, the sheet hook protrudes from a portion of the first side wall, and the protrusion of the optical sheet is received in the sheet hook opening.

10. The display apparatus of claim 9, wherein the first support member is formed by bending a metal plate.

11. The display apparatus of claim 1, further comprising:
a second support member that includes a second panel support portion is disposed parallel to the display panel, a second light guide plate support portion is disposed parallel to the second panel support portion, and a second side wall that connects the second light guide plate support portion to the second panel support portion and extends in a direction perpendicular to the second panel support portion; and
a second light guide plate adhesive member that is disposed between the light guide plate and the display panel, and that is attached to the light guide plate and the display panel, and
wherein the, light source unit is disposed adjacent to a first side of the display panel, the first and second support members are disposed adjacent to a third and fourth side of the display panel, respectively, wherein the third and fourth sides are perpendicular to the first side, and
the second light guide plate adhesive member is disposed adjacent to a second side of the display panel opposite to the first side.

12. The display apparatus of claim 1, wherein the light source unit emits blue light to the light guide plate.

13. The display apparatus of claim 12, wherein an inner surface of the first support member is yellow.

14. The display apparatus of claim 1, wherein the light exit surface of the light guide plate comprises a quantum dot pattern that includes a quantum dot or a quantum layer.

15. The display apparatus of claim 1, further comprising an additional adhesive member disposed between the light guiding plate and the first light guiding plate supporting portion of the first supporting member.

16. The display apparatus of claim 1, further comprising a frame that receives the supporting member and the light source unit.

17. The display apparatus of claim 16, further comprising a back plate fixed to the frame and that covers a lower surface of the light guiding plate.

18. The display apparatus of claim 17, further comprising a reflecting plate disposed between the back plate and the light guiding plate.

19. A display apparatus, comprising:
a display panel;
a light guide plate disposed under the display panel and that includes a light incident surface and a light exit surface;
a light source unit that faces the light incident surface of the light guide plate;
a support member that includes a panel support portion, a side wall and a light guide plate support portion;
an adhesive member disposed between the panel support portion and the display panel; and
a light guide plate adhesive member disposed adjacent to the light incident surface of the light guide plate between the light guide plate and the display panel, and that is attached to the light guide plate and the display panel.

20. The display apparatus of claim 19, wherein a quantum dot pattern comprising a quantum dot or a quantum layer is formed on the light exit surface of the light guiding plate.
